(19) United States
(12) Patent Application Publication
(10) Pub. No.: US 2025/0050207 A1
(43) Pub. Date: Feb. 13, 2025

(54) Record and Replay of Game State in a Virtual Environment

(71) Applicant: Roblox Corporation, San Mateo, CA (US)

(72) Inventors: David O’SULLIVAN, San Mateo, CA (US); Kyle Joseph SPENCE, Redwood City, CA (US); Aykud GONEN, San Mateo, CA (US); David M. LYU, San Mateo, CA (US); Chi Ming WONG, San Mateo, CA (US)

(73) Assignee: Roblox Corporation, San Mateo, CA (US)

(21) Appl. No.: 18/231,098

(22) Filed: Aug. 7, 2023

(51) Int. Cl. A63F 13/497; A63F 13/52; A63F 13/75; A63F 13/79; G06T 17/00

(52) U.S. Cl. CPC A63F 13/497; A63F 13/52; A63F 13/75; A63F 13/79; G06T 17/00

(57) ABSTRACT

A metaverse application receives user input from a user during gameplay of a virtual experience. The metaverse application renders a first game state of gameplay of the virtual experience on a user device based on the user input, wherein the first game state is described by a set of properties. The metaverse application generates a list of changes in properties between the first game state and a second game state, wherein the second game state occurred before the first game state. The metaverse application receives a request from the user to replay the second game state. The metaverse application renders the second game state of gameplay by reversing the list of changes between the first game state and the second game state.

### BACKGROUND

Abuse in a virtual environment occurs in multiple ways. For example, avatars may wear offensive outfits, players may perform offensive actions, players may say offensive things, and players may type offensive words into a group chat. Proving that a player committed abuse by performing an offensive action or saying an offensive thing, is difficult to prove because it requires reviewing the alleged abuse. Recording all things that occur in a three-dimensional (3D) virtual environment is not feasible due to the technical requirements, e.g., the amount of storage space needed to store recordings, game state, or other information; network resources to transmit such information; processing resources to process such information (e.g., encode/decode, transform formats, etc.).

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments relate generally to a system and method to store changes to a game state for replaying a previous game state. According to one aspect, a method includes receiving user input from a user during gameplay of a virtual experience. The method further includes rendering a first game state of gameplay of the virtual experience on a user device based on the user input, wherein the first game state is described by a set of properties. The method further includes generating a list of changes in properties between the first game state and a second game state, wherein the second game state occurred before the first game state. The method further includes receiving a request from the user to replay the second game state. The method further includes rendering the second game state of gameplay by reversing the list of changes between the first game state and the second game state.

In some embodiments, the method further includes displaying a user interface that includes options to replay the gameplay from the second game state to the first game state, display the gameplay backwards from the first game state to the second game state, pause the gameplay, and return to a current game state of gameplay of the virtual experience. In some embodiments, the method further includes receiving a selection from the user of an option to display the gameplay backwards from the first game state to the second game state and decrementing a frame counter while reversing the list of changes from the first game state to the second game state. In some embodiments, the user interface further includes an option to report abuse that occurs in the virtual experience by identifying one or more frames between the first game state and the second game state where the abuse occurred and identifying one or more avatars associated with the abuse. In some embodiments, the option to report abuse that occurs in the virtual experience further includes identifying an abusive object and the method further includes identifying, based on the list of changes, a player that is associated with the abusive object. In some embodiments, the user interface further includes an option to view a heatmap of an avatar that is used to illustrate how a new player can move in the virtual environment. In some embodiments, the user interface further includes an option to report a translation error that occurs in the virtual experience and to provide an alternative translation. In some embodiments, the translation error is identified as being associated with an object in the virtual experience. In some embodiments, the method further includes in response to a size of the list of changes exceeding a predetermined size threshold, removing one or more oldest changes in the list. In some embodiments, the method further includes the changes between the first game state and the second game state are grouped by a frame number in which one or more of the changes occurred.

According to one aspect, a system includes a processor and a memory coupled to the processor, with instructions stored thereon that, when executed by the processor, cause the processor to perform operations comprising: receiving user input from a user during gameplay of a virtual experience, generating a list of changes in properties between a first game state and a second game state based on the user input, wherein the second game state occurred before the first game state, receiving a report of abuse from the user that includes a recording of the gameplay from the first game state to the second game state and a player or an object associated with the abuse, and providing the report of abuse to a moderator or a machine-learning model to output a determination of abuse.

In some embodiments, the report includes an identification of abuse that occurs in the virtual experience and one or more frames between the first game state and the second game state where the abuse occurred. In some embodiments, the operations further include determining a player associated with the object based on the list of changes. In some embodiments, operations further include, responsive to determining that the player committed the abuse, muting, blocking, or placing a temporary ban on the player. In some embodiments, the operations further include, responsive to determining that the object is abusive, hiding the object from view.

According to one aspect, non-transitory computer-readable medium with instructions that, when executed by one or more processors at a user device, cause the one or more processors to perform operations, the operations comprising: receiving user input from a user during gameplay of a virtual experience, rendering a first game state of gameplay of the virtual experience on a user device based on the user input, wherein the first game state is described by a set of properties, generating a list of changes in properties between the first game state and a second game state, wherein the second game state occurred before the first game state, receiving a request from the user to replay the second game state, and rendering the second game state of gameplay by reversing the list of changes between the first game state and the second game state.

In some embodiments, the operations further include displaying a user interface that includes options to replay the gameplay from the second game state to the first game state, display the gameplay backwards from the first game state to the second game state, pause the gameplay, and return to a current game state of gameplay of the virtual experience. In some embodiments, the operations further include receiving a selection from the user of an option to display the gameplay backwards from the first game state to the second game state and decrementing a frame counter while reversing the list of changes from the first game state to the second game state. In some embodiments, the user interface further includes an option to report abuse that occurs in the virtual experience by identifying one or more frames between the first game state and the second game state where the abuse occurred. In some embodiments, wherein the option to report abuse that occurs in the virtual experience further includes identifying one or more avatars associated with the abuse.

The application advantageously describes a way to replay a game state in a virtual environment. By generating a list of changes in properties between a second game state and a first game state, the metaverse application can apply the changes to replay the virtual environment from the second game state to the first game state. This approach is a low-cost solution with a variety of applications, including a way for moderators to review the game state associated with a report of abuse, a report of translation errors, create training videos, and debugging problems in the virtual environment.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3 is an example graphic of a timeline with a first game state and a second game state, according to some embodiments described herein.

FIG. 4 is an example user interface to replay a game state, according to some embodiments described herein.

FIG. 5 includes an example user interface to report a translation error, according to some embodiments described herein.

FIG. 6 includes an example user interface to report abuse in a virtual experience, according to some embodiments described herein.

FIG. 7 includes an example user interface with an overlay that includes a list of avatars and objects that are user-selectable to provide a report of abuse, according to some embodiments described herein.

FIG. 8 includes an example user interface with a summary of the report of abuse, according to some embodiments described herein.

FIG. 9 is a flow diagram of an example method to render a second game state of gameplay, according to some embodiments described herein.

FIG. 10 is a flow diagram of an example method to render a second game state of gameplay for a report of abuse, according to some embodiments described herein.

### DETAILED DESCRIPTION

During gameplay in a virtual environment, there are many instances where a recording of events may be useful. For example, if a player submits a report of abuse that accuses another player of committing an abusive action, a recording of the event is helpful to be reviewed by a moderator or provided to a machine-learning model that analyzes the recording to confirm or reject the player's accusation. In another example, the recording may be helpful to submit with a report of a translation error (e.g., where an object in the virtual environment includes text that was translated incorrectly from a first language to a second language) so that an administrator can review the recording to determine if the translation is incorrect and fix the error so that the virtual environment contains correct translations. In yet another example, a recording of an avatar in a game may be helpful to use for training purposes. For example, the avatar can be anonymized, and the recording could be provided to other players as a guide for how to navigate or perform other actions in the virtual experience.

Previous technology prevented recordings of a game state from being saved because the memory and storage space, network bandwidth, and processing requirements for storing a three-dimensional (3D) virtual experience was very demanding. The methods, systems, and computer-readable media described herein solve this problem by generating a list of changes in properties between a first game state and a second game state, where the second game state occurred before the first game state. Generating the list of changes also include generating a reverse list of changes. The list of changes may be forwarded to a backend device (i.e., a server) and the reverse list of changes may be stored locally on a user device associated with the player.

When a user initiates a particular recording, the second game state can be rendered by reversing the list of changes between the first game state and the second game state. The list of changes may be kept small by discarding older changes in the list of changes when the size of the list exceeds a predetermined threshold. In some examples, the second game state can be accessed by entering a feedback mode where the user can provide feedback on issues, such as abusive behavior or translation errors.

### Example Network Environment 100

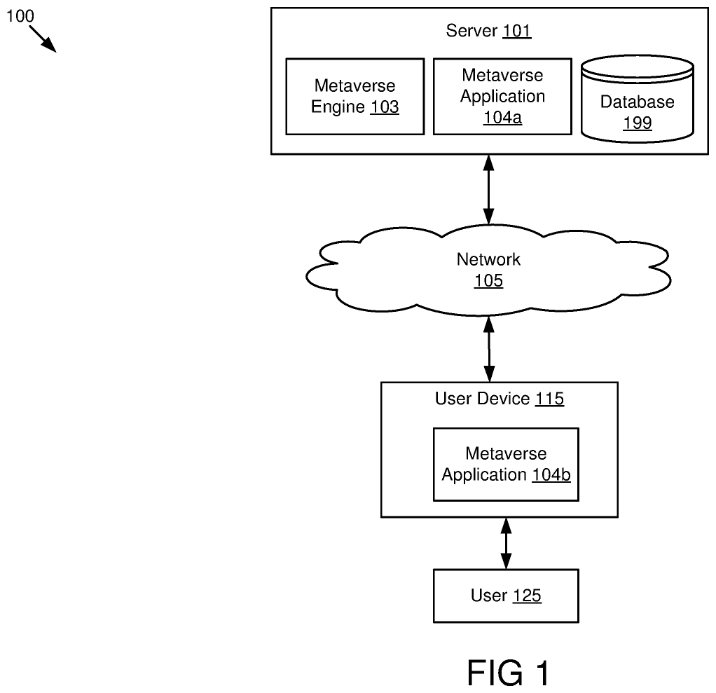

FIG. 1 illustrates a block diagram of an example environment 100. In some embodiments, the environment 100 includes a server 101 and user device 115, coupled via a network 105. User 125 may be associated with the user device 115. In some embodiments, the environment 100 may include other servers or devices not shown in FIG. 1. For example, the server 101 may include multiple servers 101 and the user device 115 may include multiple user devices 115a, n. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The server 101 includes one or more servers that each include a processor, a memory, and network communication hardware. In some embodiments, the server 101 is a hardware server. The server 101 is communicatively coupled to the network 105. In some embodiments, the server 101 sends and receives data to and from the user devices 115. The server 101 may include a metaverse engine 103, a metaverse application 104a, and a database 199.

In some embodiments, the metaverse engine 103 includes code and routines operable to generate and provide a metaverse, such as a three-dimensional (3D) virtual environment. The virtual environment may include one or more virtual experiences in which one or more users can participate as an avatar. An avatar may wear any type of outfit, perform various actions, and participate in gameplay or other type of interaction with other avatars. Further, a user associated with an avatar may communicate with other users in the virtual experience via text chat, voice chat, video (or simulated video) chat, etc.

Virtual experiences may be hosted by a platform that provides the virtual environment. Virtual experiences in the metaverse/virtual environment may be user-generated, e.g., by creator users that design and implement virtual spaces within which avatars can move and interact. Virtual experiences may have any type of objects, including analogs of real-world objects (e.g., trees, cars, roads) as well as virtual-only objects.

The virtual environment may support different types of users with different demographic characteristics (age, gender, location, etc.). For example, users may be grouped into groups such as users below 13, users between 14-16 years old, users between 16-18 years old, adult users, etc. The virtual environment platform may benefit from providing a suitable and safe experience to different users. For this purpose, the virtual environment platform may implement automated, semi-automated, and/or manual techniques to provide platform safety. Such techniques may include detection of abuse, including abusive/offensive behavior (e.g., gestures or actions performed by an avatar); abusive communication (e.g., via text, voice, or video chat); inappropriate objects (e.g., avatars wearing clothing with inappropriate words or symbols; objects of inappropriate shapes and/or motion); etc.

In some embodiments, the metaverse application 104a includes code and routines operable to receive user input from a user device 115 during gameplay of a virtual experience. The metaverse application 104a generates a list of changes in properties between a first game state and a second game state, where the second game state occurred before the first game state. The metaverse application 104a may receive a report of abuse from the user that includes a recording of the gameplay from the first game state to the second game state and an avatar or an object associated with the abuse. The metaverse application 104a may provide the report of abuse to a moderator or a machine-learning model to output a determination of abuse.

In some embodiments, the metaverse engine 103 and/or the metaverse application 104a are implemented using hardware including a central processing unit (CPU), a field-programmable gate array (FPGA), an application-specific integrated circuit (ASIC), any other type of processor, or a combination thereof. In some embodiments, the metaverse engine 103 is implemented using a combination of hardware and software.

The database 199 may be a non-transitory computer readable memory (e.g., random access memory), a cache, a drive (e.g., a hard drive), a flash drive, a database system, or another type of component or device capable of storing data. The database 199 may also include multiple storage components (e.g., multiple drives or multiple databases) that may also span multiple computing devices (e.g., multiple server computers). The database 199 may store data associated with the virtual experience hosted by the metaverse engine 103, such as a current game state, user profiles, etc.

The user device 115 may be a computing device that includes a memory and a hardware processor. For example, the user device 115 may include a mobile device, a tablet computer, a desktop computer, a mobile telephone, a wearable device, a head-mounted display, a mobile email device, a portable game player, a portable music player, a game console, an augmented reality device, a virtual reality device, a reader device, or another electronic device capable of accessing a network 105.

The user device 115 includes metaverse application 104b. In some embodiments, the metaverse application 104b receives user input from a user during gameplay of a virtual experience. The metaverse application 104b may render a first game state of gameplay of the virtual experience on a user device based on the user input, where the first game state is described by a set of properties. The metaverse application 104b may generate a list of changes in properties between the first game state and a second game state, wherein the second game state occurred before the first game state. The metaverse application 104b may receive a request from the user to replay the second game state. The metaverse application 104b may render the second game state of gameplay by reversing the list of changes between the first game state and the second game state.

In the illustrated embodiment, the entities of the environment 100 are communicatively coupled via a network 105. The network 105 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. Although FIG. 1 illustrates one network 105 coupled to the server 101 and the user devices 115, in practice one or more networks 105 may be coupled to these entities.

### Example Computing Device 200

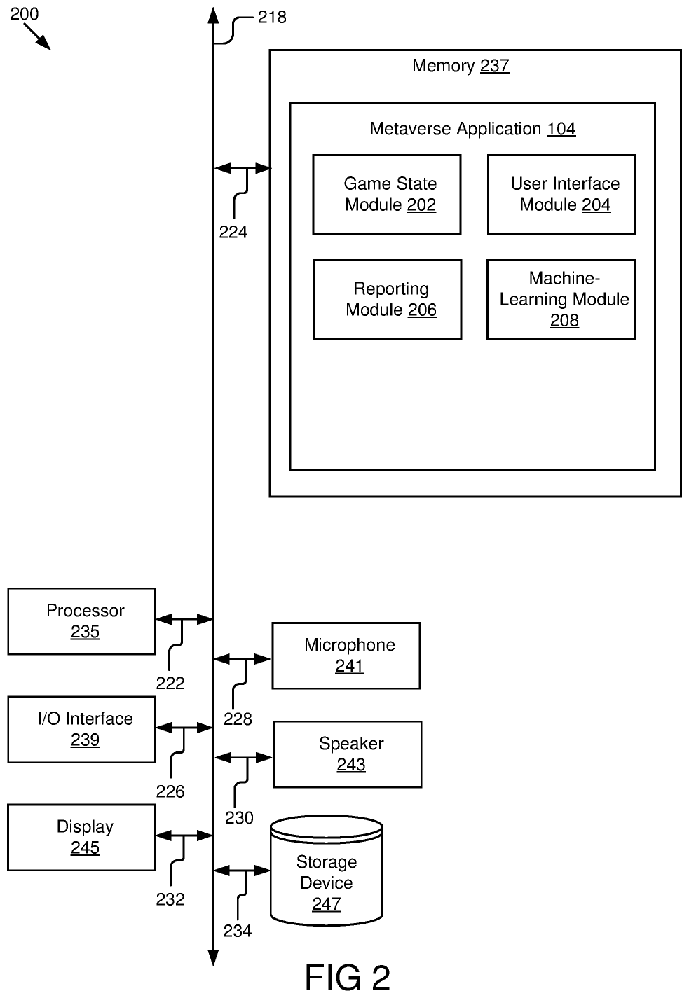

FIG. 2 is a block diagram of an example computing device 200 that may be used to implement one or more features described herein. Computing device 200 can be any suitable computer system, server, or other electronic or hardware device. In some embodiments, the computing device 200 is the user device 115. In some embodiments, the computing device 200 is the server 101.

In some embodiments, computing device 200 includes a processor 235, a memory 237, an Input/Output (I/O) interface 239, a microphone 241, a speaker 243, a display 245, and a storage device 247, all coupled via a bus 218. In some embodiments, the computing device 200 includes additional components not illustrated in FIG. 2. In some embodiments, the computing device 200 includes fewer components than are illustrated in FIG. 2. For example, in instances where the metaverse application 104 is stored on the server 101 in FIG. 1, the computing device may not include a microphone 241, a speaker 243, or a display 245.

The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the display 245 may be coupled to the bus 218 via signal line 232, and the storage device 247 may be coupled to the bus 218 via signal line 234.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. In some implementations, the processor 235 may include special-purpose units, e.g., machine learning processor, audio/video encoding and decoding processor, etc. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200, such as a keyboard, mouse, etc.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the metaverse application 104, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 247), and input/output devices can communicate via I/O interface 239. In another example, the I/O interface 239 can receive data from the server 101 and deliver the data to the metaverse application 104 and components of the metaverse application 104, such as the user interface module 204. In some embodiments, the I/O interface 239 can connect to interface devices such as input devices (keyboard, pointing device, touchscreen, microphone 241, sensors, etc.) and/or output devices (display 245, speaker 243, etc.).

Some examples of interfaced devices that can connect to I/O interface 239 can include a display 245 that can be used to display content, e.g., images, video, and/or a user interface of the metaverse as described herein, and to receive touch (or gesture) input from a user. Display 245 can include any suitable display device such as a liquid crystal display (LCD), light emitting diode (LED), or plasma display screen, cathode ray tube (CRT), television, monitor, touchscreen, three-dimensional display screen, a projector (e.g., a 3D projector), or other visual display device.

The microphone 241 includes hardware, e.g., one or more microphones that detect audio spoken by a person. The microphone 241 may transmit the audio to the metaverse application 104 via the I/O interface 239.

The speaker 243 includes hardware for generating audio for playback. In some embodiments, the speaker 243 may include audio hardware that supports playback via an external, separate speaker (e.g., wired or wireless headphones, external speakers, or other audio playback device) that is coupled to the computing device 200.

The storage device 247 stores data related to the metaverse application 104. For example, the storage device 247 may store a user profile associated with a user 125, a list of blocked avatars, etc.

### Example Metaverse Application 104

FIG. 2 illustrates a computing device 200 that executes an example metaverse application 104 that includes a game state module 202, a user interface module 204, a reporting module 206, and a machine-learning module 208. In some embodiments, a single computing device 200 includes all the components illustrated in FIG. 2. In some embodiments, one or more of the components may be on different computing devices 200. For example, the user device 115 may include the game state module 202, the user interface module 204, and the reporting module 206, while the machine-learning module 208 is implemented on the server 101.

In some embodiments, different portions of one or more of modules 202-208 may be implemented on the user device 115 and on the server 101.

The game state module 202 may receive user input from a user during gameplay of a virtual experience. For example, the user may instruct an avatar associated with the user in the virtual experience to move. The game state module 202 renders a first state of gameplay of the virtual experience on the computing device 200 based on the user input. For example, the game state module 202 may instruct the user interface module 204 to generate graphical data for displaying the avatar moving as instructed by the user input.

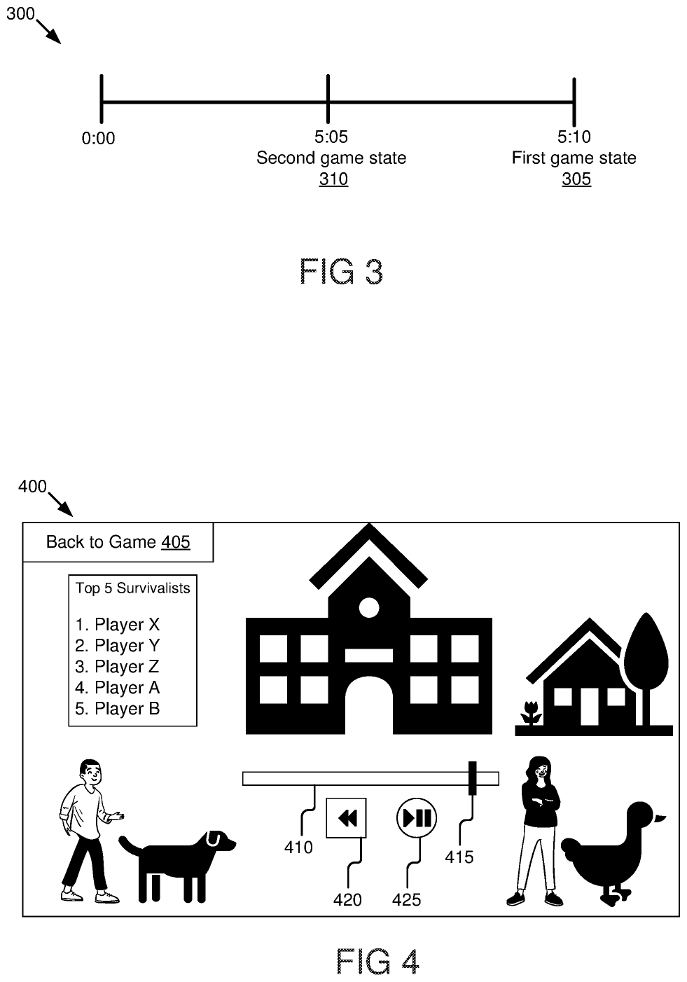

The first game state may be a current game state as compared to a second game state that happens in the past. Turning to FIG. 3, an example graphic 300 of a timeline is illustrated. The game may start at time 0:00 and continue until 5:10. The game state at 5:10 is referred to as the first game state 305. The second game state 310 occurred in the past at 5:05. In some embodiments, the user may want to view the second game state 310.

Game states are described by a set of properties associated with objects. For example, the properties of objects may include size, texture, position, color, etc. The game state module 202 generates a list of changes in properties between different game states. When a property of an object changes, the game state module 202 adds the difference as an element in the list of changes. Thus, the difference between the first game state and the second game state may be described by the elements in the list of changes that occurred between the first game state and the second game state. Storing properties of the game state is more advantageous than capturing a graphic representation of the game state because the information is richer. For example, instead of using computer vision to infer that a shirt changed from purple to yellow by comparing differences between game states, the game state module 202 stores the text description associated with the user interface element that describes the change from purple to yellow.

The virtual environment may include different object frames. The object frames are objects that render as a plain rectangle with no other content that serve as containers for other objects. Any object that is within a frame may be considered a descendant of the frame. When a change is made to a descendant of the frame (e.g., a color of an object is changed from red to green), the game state module 202 identifies the change and adds the change to the list of changes.

In some embodiments, the list of changes also includes changes made to the rules of physics within the game or virtual environment. The rules of physics may change, for example, when the rules for how mass is calculated in a body changes from being at the hull of the body to the mass being evenly distributed throughout the body. In some embodiments, changes to physics rules are made as changes to an object frame that includes an object that is affected by the rule change. In some embodiments, a change to the rule of physics may be added to the list of changes as separate entries for each object that is affected by a change to the rule of physics.

In some embodiments, each object within the game or virtual experience is associated with a universal identifier (UID). Each difference in the list of changes may include the UID so that it is possible to identify the particular object being changed. The UID may be useful when a particular object is removed between game states. By including the UID as part of the list of changes, it is possible to recreate the object that was removed from the virtual environment when the game state is played back from the second game state to the first game state. In some embodiments, the list of changes includes the UID of the object, a type of object, a description of the change (e.g., a change to a property of the object, such as changing a shirt associated with an avatar), and a new value for the property (e.g., the shirt is changed from a sleeveless yellow shirt to a long-sleeved navy shirt).

The list of changes may be applied using one or more data structures. In some embodiments, the list of changes may be a queue of changes, which is characterized by elements that are stored in a First In First Out (FIFO) order. In some embodiments, each element in the list of changes represents changes associated with a particular frame in frames of a game state. The queue may be advantageous because changes are added to an end of the queue and older changes are dropped from the end of the queue. For example, if the queue is Frame 0, then Frame 2 is added, then Frame 5 is added, if the list of changes reaches a size threshold, the first frame that is removed is Frame 0.

In some embodiments, the list of changes may be implemented as a stack, which is characterized by elements that are stored using a Last In First Out (LIFO) order. Other data structures may be used to store the changes.

In some embodiments, the list of changes is maintained at a particular size, such as 10 megabytes, when the list of changes is stored on the user device. If a size of the list of changes exceeds a predetermined size threshold, the game state module 202 may remove one or more of the oldest changes in the list. In some embodiments, certain changes may be flagged to prevent their removal. For example, if the changes are associated with an abuse report, the changes may be kept for a longer period of time. Other limitations on the list of changes may be used. For example, the game state module 202 on the server may maintain a list of changes based on how much time has passed, such as the last day, two days, an hour, etc. since the game sate that the list of changes corresponds to has elapsed. The size of the list of changes may vary based on the complexity of the virtual environment, based on a likelihood of abuse in a particular game, based on a user-customizable setting, etc. In some embodiments, the size of the list of changes may be based on a current memory capacity of a user device. For example, if a player enters an area of the virtual experience that takes up a larger percentage of the user device's memory capacity, the game state module 202 may reduce a threshold size of the list of changes.

In some embodiments, the game state module 202 generates a list of changes on a user device and transmits the list of changes to the backend (i.e., the server 101 illustrated in FIG. 1). At the time that the list of changes is generated, the game state module 202 also generates a reverse list of changes that is stored locally at the user device.

In some embodiments, the list of changes stored on the server includes all changes to the game state that occur in the 3D virtual environment, where the 3D virtual environment includes a combination of 3D virtual experiences that are experienced by individual users. As a result, the list of changes includes changes performed by an avatar that is not viewed by other avatars. For example, an avatar can make offensive gestures or say offensive things inside a house with no other avatars inside.

The game state module 202 receives a request from the user to replay the second game state. For example, the user may select an option from a user interface, such as entering a feedback mode so that the user can submit a report of abuse or identify a translation error, such as a translation of text on an object in the virtual environment that was translated incorrectly from a first language to a second language.

The game state module 202 that is used locally on the user device may generate a separate instance of the first game state and reverse the list of changes between the first game state and the second game state in order to render the second game state. The game state module 202 may reverse the list of changes by applying changes backwards and replacing the list of changes with their reverse. For example, the change of color of an object from red to green is reversed so that the object in the second game state goes back to being red. To apply forwards, the game state module 202 applies changes forward and replaces the list of changes with their reverse. For instances where the game state module 202 is playing a replay from the backend on the server, the game state module 202 on the backend starts playing forwards.

The game state module 202 may apply the list of changes to a separate first game state since the gameplay may continue to run on the original first game state in the background. When the user is done with replaying to the second game state, such as by ending the feedback mode, the user is returned to a current game state that takes place in the future from the first game state.

In some embodiments, the gameplay is characterized by frame numbers. For example, a unique frame number may be associated with each frame between the first game state and the second game state or a number of frames between the first game state and the second game state are counted. The game state module 202 may group the changes in the list of changes based on a frame number in which the changes occurred. When the game state module 202 applies the list of changes to the first game state, the game state module 202 increments a frame counter for every frame until a frame number is associated with changes from the list of changes. The game state module 202 then applies those changes and continues to increment the frame counter until the game state module 202 reaches the second game state.

In some embodiments, the game state module 202 applies the list of changes such that the gameplay is displayed backwards from the first game state to the second game state. The game state module 202 may decrement the frame counter and apply reverse changes from the first game state to the second game state.

The following is an example with three frames:
1. (Frame 0) Block X is created at position 0 with color red
2. (Frame 1) Block X's color is set to green
3. (Frame 2) Block X's position is set to 1.

The list of changes (deltas) that is ingested to the backend is as follows: {[CreateDelta type=Block, startingProperties=[position=0, color=Red], uid=X], [PropertyDelta, uid=X, color=Green], [PropertyDelta, uid=X, position=1]}

The list of changes that is stored locally (which is the reverse of the changes in the previous paragraph) is: {[RemoveDelta, uid=X], [PropertyDelta, uid=X color=Red], [PropertyDelta, uid=X, position=0]}.

If the list of changes is too large, Frame 0 reverse change is dropped first ([RemoveDelta, uid=X].

In this example, the player enters feedback mode right after Frame 2. The local replay works as follows:

(1) The game state module 202 copies over the current game state and displays the current game state to the player, which looks the same as when the user enters replay mode.

(2) If the player selects a rewind button, the game state module 202 applies the locally stored list of changes in refer so the following happens in order:
1. Apply [PropertyDelta, uid=X, position=0]: Block X's position is set to 0. This change is replaced with a new change with value [PropertyDelta, uid=X, position=1]
2. Apply [PropertyDelta, uid=X color=Red]: Block X's color is set to Red. This change is replaced with a new change with value [PropertyDelta, uid=X color=Green]
3. Apply [RemoveDelta, uid=X]: Block X is Removed. This change is replaced with a new change with value: [CreateDelta type=Block, startingProperties=[position=0, color=Red], uid=X]

(3) The game state module 202 is now at the state before any changes to the game state occurred and the list of changes looks like: {[CreateDelta type=Block, startingProperties=[position=0, color=Red], uid=X], [PropertyDelta, uid=X, color=Green], [PropertyDelta, uid=X, position=1]}. This is the same list of changes that the game state module 202 would ingest at the backend.

(4) If the game state module 202 plays forwards from here, the game state module 202 performs the same steps as above, but follows the list in order:
a. Apply [CreateDelta type=Block, startingProperties=[position=0, color=Red], uid=X]: Block X is created at position 0 with color Red. This change is replaced by a new change with value: [RemoveDelta, uid=X]
b. Apply [PropertyDelta, uid=X, color=Green]: Block X's color is set to Green. This change is replaced by a new change with value: [PropertyDelta, uid=X color=Red] Apply [PropertyDelta, uid=X, position=1]: Block X's position is set to 1. This change is replaced by a new change with value: [PropertyDelta, uid=X, position=0]

(5) The game state module 202 is now in the same state as when the player originally entered feedback mode and the list of changes is the same as when the player originally entered feedback mode. The player can repeat the process above starting with step (2) if desired. The above steps are performed locally, but if the replay was performed from backend ingested changes, the steps would be the same starting with the step (4).

The game state module 202 does not need to rewind entirely to the start or play entirely to the end. For example, the player may jump back and forth between Frame 2 and Frame 1 using the above steps since the change is not replaced with its reverse until it is actually applied to the game state.

The user interface module 204 generates graphical data for displaying a user interface for users associated with user devices to participate in a 3D virtual experience. In some embodiments, before a user participates in the virtual experience, the user interface module 204 generates a user interface that includes information about how the user's information may be collected, stored, and/or analyzed. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

The user interface module 204 receives user input from a user during gameplay of a virtual experience. For example, the user input may cause an avatar to move around, perform actions, change poses, etc. in the virtual experience. The user interface module 204 generates graphical data for displaying the location, actions, poses, etc. of the avatar within the virtual experience.

The avatar may interact with other avatars in the virtual experience. Some of these interactions may be negative and, in some embodiments, the user interface module 204 generates graphical data for a user interface that enables a user to request to report abuse that occurs in the virtual experience. For example, another avatar may be wearing an objectionable piece of clothing, an avatar may be holding an inappropriate object (e.g., a flag associated with a hate group, an object in the shape of something offensive, etc.), an avatar may perform an offensive action (e.g., the avatar may use spray paint to draw an image of genitals), or an avatar may utter an inappropriate phrase (e.g., either in a chat box or directly via voice chat to the user). One avatar may also be associated with multiple types of abuse, such as wearing inappropriate clothing while performing an offensive act.

The user interface may receive a request from the user to replay from the first game state to a second game state. In some embodiments, the user may trigger the replay by requesting to be in feedback mode, for example, from a button or a drop-down menu. In some embodiments, the feedback mode may include an option for saving a recording of the replay from the first game state to the second game state.

The recording may be used as a teaching video to show other players how to act in a virtual environment (subject to the player providing permission and/or the avatar being anonymized). In one example, the user interface may include an option to view the movement of an avatar where the movement is turned into a heatmap that is used to illustrate how new players can move in the virtual environment. The heatmaps may represent the best way to move, alternative options for how to move, the most popular path in the virtual environment, etc.

The user interface module 204 may generate graphical data to display a user interface with controls for selecting the second game state. FIG. 4 is an example user interface 400 to replay a game state. In some embodiments, the game state is current when the user interface 400 is displayed, but the current state stops updating with new information. In this example, the user interface 400 includes an option to return to a current game state of gameplay of the virtual experience by selecting a return back to the game button 405. The button 405 also functions as a reminder to the user that the displayed user interface 400 is not the current state of the game because the user interface 400 does not update with new changes to the game state.

The user interface 400 includes a slider 410 that represents the length of the gameplay, e.g., from the beginning (or the last available game state in the list of changes) to the current game state. The user may select the bar 415 to change the game state. In some embodiments, moving the bar 415 to a particular location on the slider 410 causes the game state module 202 to replay the virtual experience from the selected game state to the first game state.

The user interface 400 includes a rewind button 420. Selecting the rewind button 420 causes the game state module 202 to apply the list of changes so that the user interface module 204 generates graphical data for displaying the gameplay backwards from one game state (e.g., the first game state) to an earlier game state (e.g., the second game state).

In some embodiments, a user may select the rewind button 420 in the user interface to cause the computing device 200 to display the gameplay backwards from the first game state to the second game state. The game state module 202 may display the gameplay backwards by decrementing the frame counter and applying reverse changes from the first game state to the second game state, where the user interface module 204 generates the graphical data for displaying the different game states.

The user interface 400 includes a play/pause button 425. When the virtual experience is replaying, the user may select the play/pause button 425 once to pause the replay and a second time to play the replay.

In some embodiments, with user permission, the recording can be used for debugging purposes. A user can use a recording from the second game state to the first game state to identify a spot in the virtual experience where an obvious error is occurring. For example, the virtual experience may include an object that is misbehaving, an artifact that does not belong, etc.

In some embodiments, the user interface module 204 generates a user interface that includes an option to report a translation error that occurs in the virtual experience. The user may enter the feedback mode and move the game state to a time when an object with a translation error is visible. The user may then click on a particular object to trigger the option for reporting a translation error. Alternatively, the user may enter feedback mode and the user interface may provide a list of all the objects in the frame that include text that could have a translation error.

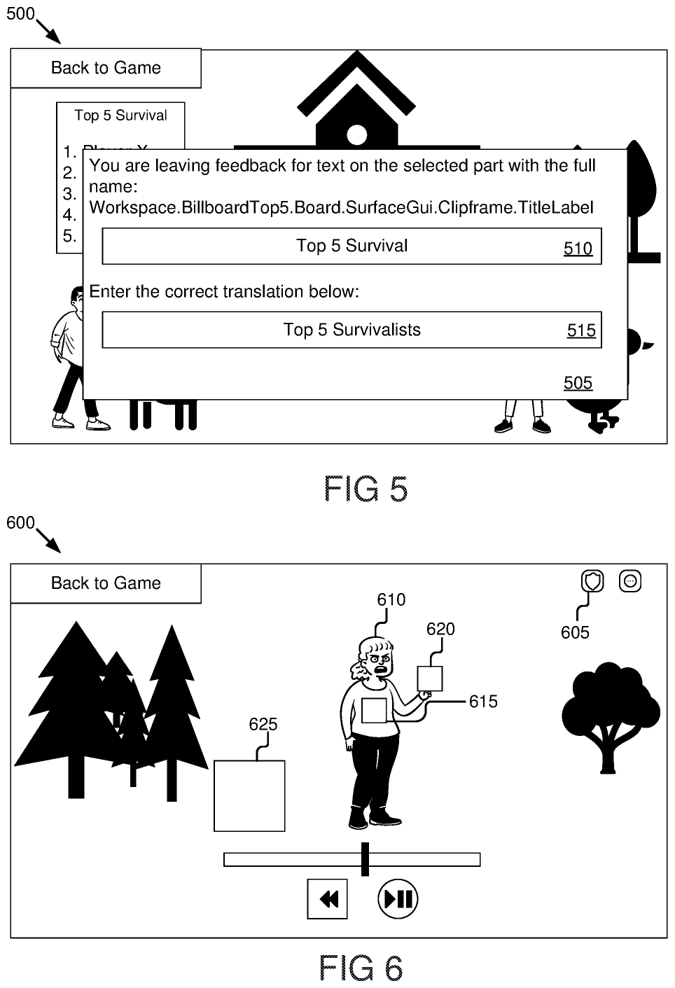

FIG. 5 includes an example user interface 500 to report a translation error. In this example, the user selected the object with the name “Workspace.BillboardTop5.Board.SurfaceGui.Clipframe.TitleLabel” and the user interface module 204 generated the user interface 500 with a report box 505. The report box 505 includes the name of the object in a first field 510 and the corrected name for the object provided by the user in a second field 515. The report of the translation error may be submitted with a recording or a 2D screenshot that includes where the translation error occurred.

In some embodiments, a user may want to report abuse that occurs during their virtual experience. The user interface may include a report button, which indicates that the user wants to report abuse, such as an inappropriate avatar, an inappropriate voice input, an inappropriate action, an inappropriate object, or a combination of different types of abuse.

In some embodiments, the user interface module 204 generates graphical data for displaying a user interface that includes an option to report abuse that occurs in the virtual experience that includes identifying one or more frames between the first game state and the second game state where the abuse occurred. For example, when a user is in the virtual experience something objectionable may occur. The user may enter feedback mode and move the game state to a time when the abuse occurred. The user may then select a box to report the abuse.

FIG. 6 includes an example user interface 600 to report abuse in a virtual experience. In this example, the user requests to report abuse by selecting a report icon 605. Other mechanisms for selection are possible. For example, the user may pause the playback, select a particular object, and the user interface module 204 may provide a box with a list of actions that including reporting the selected object.

The virtual experience may include many types of abuse. For example, an avatar 610 may be associated with offensive voice input, the avatar 610 may be wearing offensive clothing 615, the avatar 610 may be performing an offensive action, such as an offensive gesture 620, the virtual experience may include offensive objects 625, or a player may provide abuse via a chat box and/or via voice chat (not shown).

In some embodiments, when a user identifies an abusive object, the game state module 202 may identify a player that is associated with the abuse. For example, an avatar associated with a user may enter a virtual environment where another avatar used spray paint to draw an indecent shape on a wall. Because the avatar associated with the user joined the virtual environment after the action was performed, the user has no way of knowing who performed the action. However, the game state module 202 on the server may keep track of the list of changes for the entire 3D virtual environment and for longer than the list of changes stored on the user device. As a result, the game state module 202 may receive the report of abuse (“this wall has an indecent shape”) and identify player that performed the action based on the list of changes. In this case, there may be no replay provided (since the avatar joined the game after the creation of the offensive entity). In some embodiments, a moderator may determine the player that performed the action by requesting the game state module 202 to display the game state backwards until the moderator identifies the perpetrator.

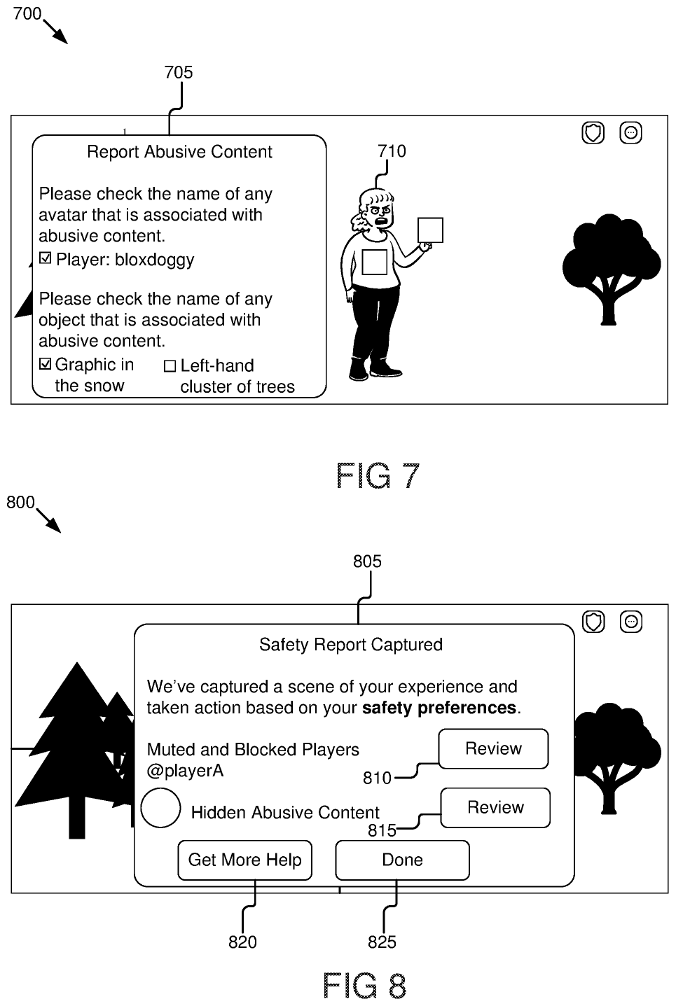

In some embodiments, once a user stops at a particular game state, the user interface module 204 may determine a list of avatars and objects in the frame to help the user to complete a report of abuse. FIG. 7 includes an example user interface 700 with an overlay that includes a list of avatars and objects 705 that are user-selectable to provide a report of abuse. In this example, the list of avatars and objects 705 includes avatar 710, which belongs to Player A, and a graphic in the snow (that is obscured by the list of avatars and objects 705). In some embodiments, the user interface module 204 generates a list of avatars based on whether the avatars are visible to the user in the virtual experience.

The report of abuse may include a recording from the second game state to the first game state or one or more 2D screenshots of frames that occur between the second game state and the first game state. The recording or the 2D screenshot may serve as evidence of the abuse that occurred.

The reporting module 206 receives the request to report abuse. The report of abuse may be viewed by a moderator and/or submitted to the machine-learning module 208 that outputs a determination of whether players and objects identified in the report of abuse are associated with actual abuse or not. Based on receiving the report of abuse, the reporting module 206 may block and/or mute a player. In some embodiments, if the player has committed previous acts of abuse, the reporting module 206 may apply a temporary ban of the user (one day, three days, etc.). If the report of abuse includes an identification of an inappropriate object, the reporting module 206 may hide the inappropriate object from the virtual experience for the user or remove the inappropriate object from the virtual environment altogether so that other users are not exposed to the inappropriate object.

Once a decision has been made regarding the report of abuse and the reporting module 206 has applied relevant changes, the user interface module 204 may generate a summary of the report of abuse. FIG. 8 includes an example user interface 800 with a summary of the report of abuse. The summary 805 includes a list of muted and blocked players and an identification of the hidden abuse. If the user is unsure about these steps, the user may select a review button 810 for information about the muted and blocked player, a review button 815 for information about the hidden object, or a get more help button 820 for additional inquiries. If the user is satisfied, the user may select the done button 825.

The machine-learning module 208 implements a machine-learning model that is trained to output a determination of whether a play and/or an object is associated with abuse. In some embodiments, the machine-learning model is trained with a training set that includes manual labels for abuse and manual labels for non-abuse. The abuse may include inappropriate avatars, inappropriate voice input, inappropriate actions, inappropriate objects, etc. In some embodiments, the training data set includes chat logs, 2D captures, metadata, and/or other data used to output a determination of whether the avatar and/or object is associated with abuse.

The machine-learning module 208 trains the machine-learning model using the training dataset in a supervised learning fashion. In some embodiments, the machine-learning model is a deep neural network. Types of deep neural networks include convolutional neural networks, deep belief networks, stacked autoencoders, generative adversarial networks, variational autoencoders, flow models, recurrent neural networks, and attention bases models. A deep neural network uses multiple layers to progressively extract higher-level features from the raw input where the input to the layers are different types of features extracted from other modules and the outputs are a determination of whether a player committed abuse or an object is an abusive object.

The machine-learning module 208 may implement machine learning model layers that identify increasingly more detailed features and patterns within the 2D capture of the virtual experience where the output of one layer serves as input to a subsequently more detailed layer until a final output is a determination of whether a player committed abuse or an object is an abusive object. One example of different layers in the deep neural network may include token embeddings, segment embeddings, and positional embeddings.

### Example Methods

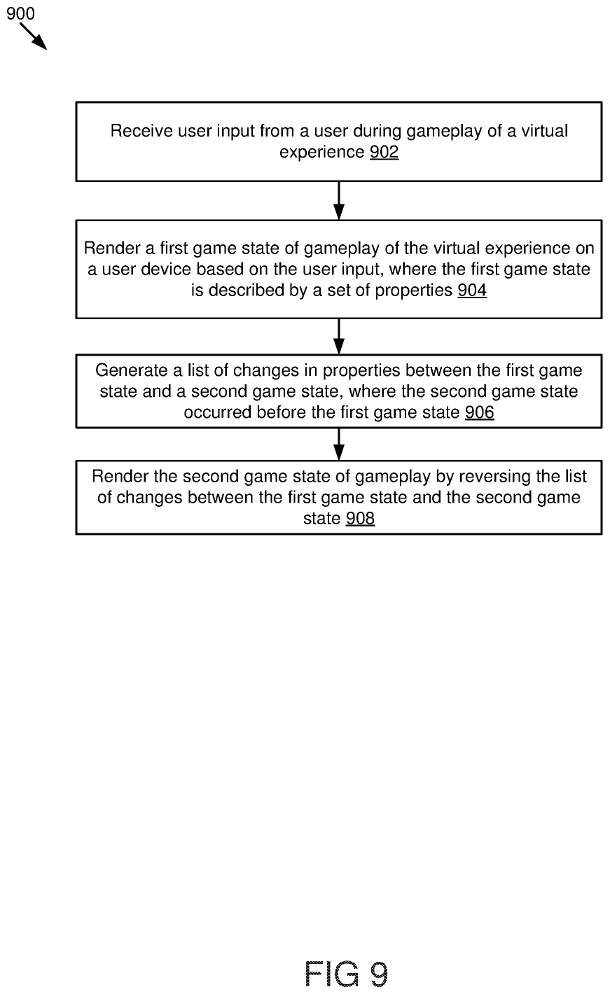

FIG. 9 is a flow diagram of an example method to render a second game state of gameplay, according to some embodiments described herein. In some embodiments, all or portions of the method 900 are performed by the metaverse application 104 stored on the user device 115 and/or the metaverse application 104 stored on the computing device 200 of FIG. 2.

The method may begin with block 902. At block 902, user input is received from a user during gameplay of a virtual experience. Block 902 may be followed by block 904.

At block 904, a first game state of gameplay of the virtual experience is rendered on a user device based on the user input, where the first game state is described by a set of properties. Block 904 may be followed by block 906.

At block 906, a list of changes in properties is generated between the first game state and a second game state, where the second game state occurred before the first game state. Block 906 may be followed by block 908. In some embodiments, the changes between the first game state and the second game state are grouped by a frame number in which one or more of the changes occurred. In some embodiments, if a size of the list of changes exceeds a predetermined size threshold, one or more oldest changes in the list are removed.

At block 908, the second game state of gameplay is rendered by reversing the list of changes between the first game state and the second game state.

In some embodiments, the method may also include displaying a user interface that includes options to replay the gameplay from the second game state to the first game state, display the gameplay backwards from the first game state to the second game state, pause the gameplay, and return to a current game state of gameplay of the virtual experience. The user may select an option to display the gameplay backwards from the first game state to the second game state. This may occur by decrementing a frame counter while reversing the list of changes from the first game state to the second game state.

In some embodiments, user interface further includes an option to report abuse that occurs in the virtual experience by identifying one or more frames between the first game state and the second game state where the abuse occurred. The option to report abuse may include identifying one or more avatars associated with the abuse. The option to report abuse may include identifying an abusive object and the method may further include identifying, based on the list of changes, a player that is associated with the abusive object.

In some embodiments, the user interface further includes an option to report a translation error that occurs in the virtual experience and to provide an alternative translation. The translation error may be identified as being associated with an object in the virtual experience.

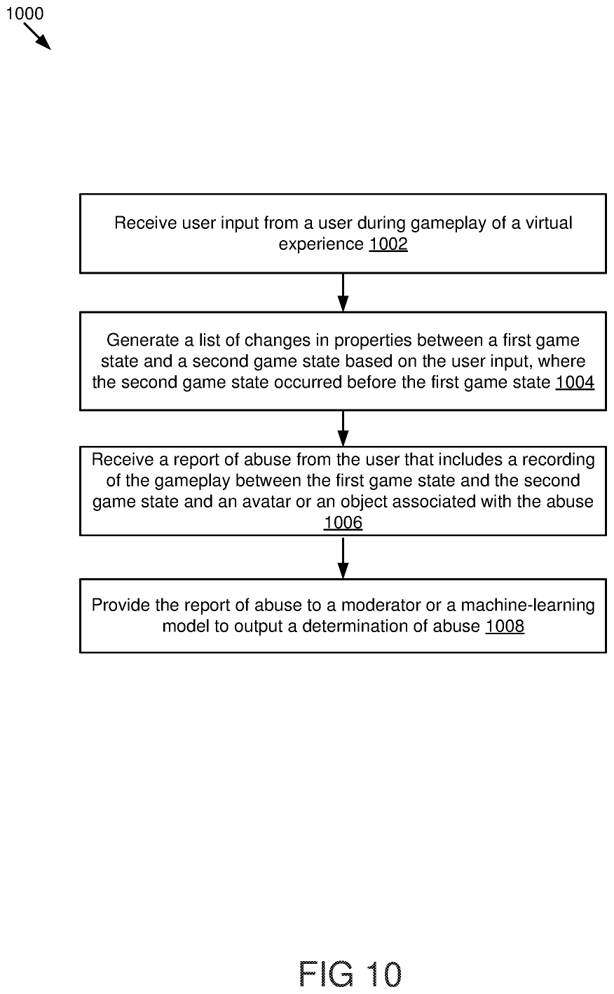

FIG. 10 is a flow diagram of an example method to render a second game state of gameplay for a report of abuse, according to some embodiments described herein. In some embodiments, all or portions of the method 1000 are performed by the metaverse application 104 stored on the server 101 as illustrated in FIG. 1 and/or the metaverse application 104 stored on the computing device 200 of FIG. 2.

The method 1000 may begin with block 1002. At block 1002, user input from a user is received during gameplay of a virtual experience. Block 1002 may be followed by block 1004.

At block 1004, a list of changes in properties is generated between the first game state and a second game state based on the user input, where the second game state occurred before the first game state. Block 1004 may be followed by block 1006.

At block 1006, a report of abuse is received from the user that includes a recording of the gameplay between the first game state and the second game state and an avatar or an object associated with the abuse. Block 1006 may be followed by block 1008.

At block 1008, the report of abuse is provided to a moderator or a machine-learning model to output a determination of abuse. The report of abuse may include an identification of the abuse that occurs in the virtual experience and one or more frames between the first game state and the second game state that correspond to the abuse. In responsive to the moderator or the machine-learning model outputting the determination of the abuse, muting, blocking, or placing a temporary ban on a player associated with the avatar. In another example, in response to determining that the object is abuse, the object may be hidden from the view of either the user that provided the report of abuse or all users.

In some embodiments, the method further includes determining a player associated with the object based on the list of changes. For example, a moderator or the metaverse application may play the gameplay backwards from the first game state to the second game state until an avatar associated with the object is visible. In another example, the list of changes may include the player associated with changing the object to make it potentially abusive.

While the foregoing description refers to a first avatar that is blocked by a user, it will be appreciated that a virtual experience may include any number of avatars, with each avatar blocking zero, one, or more other avatars. For each avatar, respective additional audio is generated (e.g., locally on the user device of the user associated with the avatar) to block out audio from the corresponding blocked avatars. In some embodiments, e.g., if a user blocks three avatars at different locations, three distinct portions of additional audio may be generated, each corresponding to a particular blocked avatar. In some embodiments, if two or more blocked avatars are co-located (at or near a same location), a single portion of additional audio may be generated corresponding to the two or more blocked avatars.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

In the above description for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiments of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer implemented method comprising:
receiving user input from a user during gameplay of a virtual experience;
rendering a first game state of gameplay of the virtual experience on a user device based on the user input, wherein the first game state is described by a set of properties;
generating a list of changes in properties between the first game state and a second game state, wherein the second game state occurred before the first game state;
receiving a request from the user to replay the second game state; and
rendering the second game state of gameplay by reversing the list of changes between the first game state and the second game state.

2. The method of claim 1, further comprising:
displaying a user interface that includes options to replay the gameplay from the second game state to the first game state, display the gameplay backwards from the first game state to the second game state, pause the gameplay, and return to a current game state of gameplay of the virtual experience.

3. The method of claim 2, further comprising:
receiving a selection from the user of an option to display the gameplay backwards from the first game state to the second game state; and
decrementing a frame counter while reversing the list of changes from the first game state to the second game state.

4. The method of claim 2, The method of claim 2, wherein the options in the user interface further include an option to report abuse that occurs in the virtual experience by identifying one or more frames between the first game state and the second game state that correspond to the abuse and identifying one or more avatars associated with the abuse.

5. The method of claim 4, wherein the option to report abuse that occurs in the virtual experience further includes identifying
an abusive object, and the method further comprises:
identifying, based on the list of changes, a player that is associated with the abusive object.

6. The method of claim 2, wherein the options in the user interface further include an option to view a heatmap of an avatar that is used to illustrate how a new player can move in the virtual environment.

7. The method of claim 2, wherein the options in the user interface further include an option to report a translation error that occurs in the virtual experience.

8. The method of claim 7, wherein the translation error is identified as being associated with an object in the virtual experience.

9. The method of claim 1, further comprising:
in response to a size of the list of changes exceeding a predetermined size threshold, removing one or more oldest changes in the list.

10. The method of claim 1, wherein the changes between the first game state and the second game state are grouped by a frame number in which one or more of the changes occurred.

11. A system comprising:
a processor; and
a memory coupled to the processor, with instructions stored thereon that, when executed by the processor, cause the processor to perform operations comprising:
receiving user input from a user during gameplay of a virtual experience;
generating a list of changes in properties between a first game state and a second game state based on the user input, wherein the second game state occurred before the first game state;
receiving a report of abuse from the user that includes a recording of the gameplay between the first game state and the second game state, and an avatar or an object associated with the abuse; and
providing the report of abuse to a moderator or a machine-learning model to output a determination of abuse.

12. The system of claim 11, wherein the report includes an identification of the abuse that occurs in the virtual experience and one or more frames between the first game state and the second game state that corresponds to the abuse.

13. The system of claim 11, wherein the operations further include determining a player associated with the object based on the list of changes.

14. The system of claim 11, wherein the operations further include, responsive to the moderator or the machine-learning model outputting the determination of the abuse, muting, blocking, or placing a temporary ban on a player associated with the avatar.

15. The system of claim 11, wherein the operations further include, responsive to determining that the object is abusive, hiding the object from view.

16. A non-transitory computer-readable medium with instructions that, when executed by one or more processors at a user device, cause the one or more processors to perform operations, the operations comprising:
receiving user input from a user during gameplay of a virtual experience;
rendering a first game state of gameplay of the virtual experience on a user device based on the user input, wherein the first game state is described by a set of properties;
generating a list of changes in properties between the first game state and a second game state, wherein the second game state occurred before the first game state;
receiving a request from the user to replay the second game state; and
rendering the second game state of gameplay by reversing the list of changes between the first game state and the second game state.

17. The non-transitory computer-readable medium of claim 16, wherein the operations further comprise:
displaying a user interface that includes options to replay the gameplay from the second game state to the first game state, display the gameplay backwards from the first game state to the second game state, pause the gameplay, and return to a current game state of gameplay of the virtual experience.

18. The non-transitory computer-readable medium of claim 17, wherein the operations further comprise:
receiving a selection from the user of an option to display the gameplay backwards from the first game state to the second game state; and
decrementing a frame counter while reversing the list of changes from the first game state to the second game state.

19. The non-transitory computer-readable medium of claim 17, The method of claim 2, wherein the options in the user interface further include an option to report abuse that occurs in the virtual experience by identifying one or more frames between the first game state and the second game state that correspond to the abuse.

20. The non-transitory computer-readable medium of claim 19, wherein the option to report abuse that occurs in the virtual experience further includes identifying one or more avatars associated with the abuse.
